(19) United States
(12) Patent Application Publication
(10) Pub. No.: US 2009/0070278 A1
(43) Pub. Date: Mar. 12, 2009

(54) Automatically Generated Metered Mail

(75) Inventor: Richard H. Rosen, Trumbull, CT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Neopost Technologies, Bagneux (FR)

(21) Appl. No.: 12/023,781

(22) Filed: Jan. 31, 2008

Related U.S. Application Data
(60) Provisional application No. 60/935,949, filed on Sep. 7, 2007.

(51) Int. Cl. G07B 17/02

(52) U.S. Cl. 705/407; 705/401

(57) ABSTRACT

Postage values are determined for a plurality of documents stored in a document file. Value-bearing indicia are generated based upon the determined values. The indicia are stored separately from the documents. The documents and the indicia are printed on the same mailpiece.

### PRIORITY

This application claims the benefit of U.S. Provisional Application No. 60/935,949 filed on Sep. 7, 2007, which is incorporated herein by reference in its entirety.

### FIELD OF THE INVENTION

The field of the invention is mail technology, and in particular the application of indicia to documents and mailpieces.

### BACKGROUND OF THE INVENTION

Producing mailpieces quickly in large volumes is important to companies such as utilities, which must bill large numbers of customers every month. The size of a mailpiece production run can be in the tens or hundreds of thousands, or even more. Further, the mailpiece printing, collating, sorting and franking equipment is expensive to acquire and operate.

One of the bottlenecks in generating mailpieces is metering and franking the mail in real-time. It is time consuming and resource intensive to determine the weight and size of a mailpiece, calculate the amount of postage needed based on current rate tables, send a request for a token to a Postage Storage Device (PSD), receive the token, convert the token into a graphic (such as an Information Bearing Indicium, or “IBI”) and print the graphic on the mailpiece. This can slow the production process in real time, lengthening the time needed for a production run. This is expensive, and requires that production runs for large jobs start sooner, preventing late charges from being reflected in, say, enclosed invoices, or else causing the invoices to be mailed later. Later mailing translates to later payment, further costing the mailer money.

One solution to this problem has been to calculate and apply the postage to a mailpiece earlier in the print production process. In particular, a series of documents to be mailed (such as invoices) can be generated and stored in a print file. Each document in the print file can be described in a Print Document Language (PDL), such as Postscript, made by Adobe Systems, Inc. A Postscript file contains data elements to be printed, such as text and graphics, along with instructions pertaining to how and where on the page the data elements are to be printed. At the printer, an interpreter interprets the instructions, reads the data and prints the data items on the page accordingly. The PDL of a document in the print file can analyzed before the start of actual production (that is, printing, collating, etc.) to determine the weight and size of the mailpiece that it will be used to produce. The postage can be calculated, a token can be requested and received, and an IBI can be generated and electronically merged into the page. The print file now contains documents that already have an IBI that will show through the window of an envelope into which the document is inserted. Production then involves printing the documents in the print file, collating the resulting documents, inserting them into envelopes and perhaps sorting the mailpieces into batches for mailing.

While the above approach eliminates the metering bottleneck during the actual production of the mailpieces, it presents certain disadvantages. Embedding an IBI within a particular page of a document makes late changes difficult. A change to a document involves locating the document in a print file that contains tens or hundreds of thousands of documents and then modifying the correct page. What is needed is a more flexible system that realizes the advantages of precalculating and performing the needed IBIs, while retaining the flexibility of being able to change the IBI associated with a particular document or page up to the time of printing.

### SUMMARY OF THE INVENTION

In accordance with an embodiment of the present invention, the documents in a print file can be analyzed for weight and size and an IBI can be generated before the documents are printed. However, the IBIs are not merged into the print file. Rather, they are applied to the mailpiece at the time of printing. The advantages of precalculating the required postage and performing the IBI are combined with the flexibility obtained by not electronically embedding the preformed IBI within a given page of a given document in a print file containing many documents.

### BRIEF DESCRIPTION OF THE DRAWINGS

FIG. 1 shows a system in accordance with an embodiment of the present invention.

### DETAILED DESCRIPTION

In accordance with an embodiment of the present invention, one or more postage indicia can be formulated based upon an electronic version of a document, such as a document in a print file. For example, the size (dimensions) and weight of a document can be calculated based on its representation in the print file and other information. The size of the document that can be analyzed can be at least one physical dimension of the mailpiece (length, width, height), the volume of the mailpiece, the geometric configuration of the mailpiece, and any other factor that can affect the cost of postage based upon shape-based pricing. The other information can include size and/or weight data about other documents (such as a credit card, other sheets of paper (such as promotional material like coupons, vouchers and advertisements), return envelopes, the envelope in which the enclosures will be mailed, and so on) that will be part of the mailpiece. The size and weight information as well as other data (such as discounts realized from pre-sorted batch mailing and information from rate tables) can be used to calculate the postage required for mailing. An IBI can be generated based on a token requested and received from a PSD and other information, such as the destination address or any part thereof, such as the destination zip code. The PSD can be local to the system that produces the documents, local to the metering system or remote. The IBI can include a hash of the destination zip code and digital signatures useful for authenticating all or part of the information in the IBI.

Each IBI can include an identifier or other information that substantially uniquely identifies the IBI. Likewise, each document and/or page in the print file can have its own document data that includes its own identifier. The identifier can be included as metadata associated with each document or page and can be included as a machine readable code (such as a barcode) on the relevant page or pages of the document. The IBI identifier can be correlated with the document or page to which it pertains using the document data. A record of such a correlation can be stored in a database. In this way, an IBI stored in one location (such as an IBI file) can be correlated with a document or page stored in a second place (such as a document print file). Either or both of the IBI and document/page identifiers may be authenticated if a digital signature is included with the identifier. For example, a hash of the IBI identifier (optionally hashed together with other information) can be signed with a private cryptographic key and authenticated using the corresponding public key. The same can be applied to a document or page identifier.

In one embodiment, a page of a document in a print file includes instructions in a PDL to print the document, not to advance the sheet of paper after the printing the document, but to retrieve an IBI from a second file, print the IBI and then to advance the sheet so that the next page may be printed. In another embodiment, the instructions are implemented in a control program implemented outside of the instructions on the page and/or outside of the print file. These instructions can cause functions to be performed that take advantage of the fact that the IBI is not embedded in the page to be printed. For example, the IBI to be printed on a mailpiece containing a given document can be changed at the time of printing, based for example on changes to postal rates, changes to the way in which the mailing is to be pre-sorted and bundled for discount, changes in the content of the mailpiece, such as the late addition of another element (such as an extra credit card or additional promotional material), and so on. An example of such a scenario can involve analyzing a print file and determining that 4,520 of the documents (invoices) will require 43 cents and 7,926 will require 56 cents. In accordance with an embodiment of the present invention, 6,000 43 cent IBIs and 8,500 56 cent IBIs are generated. Each IBI may or may not be correlated with a particular document in records in a database, as described above. Later, the mailer is made to include a form regulatory notice that will be supplied from a separate print file in each of the mailpieces. This has the effect of increasing the amount of postage required on 1,300 of the 43 cent mailpieces to 56 cents, while having no affect on the rates of the rest. Records are changed in the database to indicate that the relevant pages of the affected documents are to receive a 53 cent IBI, rather than a 43 cent IBI. At the time of printing, the control program reads the document identifier, looks up the record in the database, finds the present postage amount required, retrieves an IBI having the correct value from the IBI file and prints the IBI on the page. Were the IBI embedded in the page in the print file, it would have borne insufficient postage and the page would have to be regenerated. Advantageously, nothing in the print file had to be changed to ensure that the correct postage was affixed to the embodiment of the present invention described above.

In an embodiment of the present invention, a first bitmap based on the contents and layout of the document and a second bitmap based on the IBI is stored at the printer. The printer can superimpose the two bitmaps and print the resulting combined bitmap so that the document and the IBI are printed on the same piece of paper. In another embodiment, a first printer stores the first bitmap based upon the document and a second printer stores the second bitmap based upon the IBI. The document bitmap is printed by the first printer on a sheet of paper, which is forwarded to the second printer, which prints the IBI bitmap on the same sheet of paper. In another embodiment, a sheet of paper passes under two print heads in succession. The first print head prints the document bitmap and the second print head prints the IBI bitmap on the same sheet of paper. In these ways, a document and IBI are printed on the same piece of paper (such as a page, an envelope, and so on). Offset information can be used by one or both printers or print heads to ensure that the IBI is printed in the correct position on the paper in relation to the contents of the document.

The IBI can be printed on the lead page of a document such as an invoice, near the printed destination address so it can be seen through the window of an envelope. Position information can be included in the document information (optionally in the document indicium), in the IBI, or in a database correlated to the IBI identifier and/or the document identifier, or in a combination thereof. The position information can describe where on the page the IBI is to be printed. In one embodiment, the position information can take the form of offset parameters from a default position, such as “three pixels up and five pixels over from the default position”. It may take the form of absolute coordinates on the page. It may take the form of an offset from another element on the page, such as the destination address. The location of such an element may be specified by, for example, specifying the coordinates of the upper left corner of a box enclosing the text. The offset information may indicate that the lower left corner of a box enclosing the IBI is to be 2 pixels up and to the right of the text box point. Any suitable scheme for specifying the location of the IBI may be used in accordance with the present invention.

In another embodiment, the IBI can be pre-printed on the envelope before the document production process. A document can be printed and a document indicium (which may or may not include the value-bearing indicium) on one or more pages can be scanned as they enter the inserter. The presence and order of the documents can be checked against a record in a database that correlates the identifier with content information, such as which sheets should be present and in which order, and what other elements are to be included in the mailpiece. Alternatively, such information can be encoded into the document indicium and read and processed as they enter the inserter. If there is a discrepancy between what should in the mailpiece and what is detected by the scanner, then the set of documents can be diverted. This advantageously prevents incomplete mailpieces from being mailed. The identifier of the diverted page(s) or document can be recorded in a log and notified to be regenerated. Likewise, the IBI on an envelope can be scanned as it is fed to an inserter to receive documents for insertion. The postage amount in the IBI can be compared with the postage required for the mailpiece. If there is a disparity between the two, the envelope can be diverted and another envelope can take its place. That envelope can also be so analyzed, and so on. Likewise, the indicium can be scanned after emering from the inserter.

In an embodiment, the IBI can be printed on the envelope after the enclosures are inserted into the envelope. The particular IBI selected may be changed based upon the requirements present at the time the IBI is printed, as described above. Document indicia may be scanned as the documents are inserted into the envelope. A list of the contents actually inserted may be correlated with the IBI identifier in a database.

In one embodiment, an envelope is printed with an indicium having an identifier and a set of documents having the corresponding identifier are printed and assembled for insertion into the envelope. The envelope can advantageously be matched to the assembled document and it can be assured that the correct document is inserted into the correct envelope. This can be assured irrespective of document preparation sequence. For example, such assurance is available even when the envelope is printed before the document is printed, after the document is printed but before the document is assembled, after document assembly, or even after the document is inserted into the envelope. A record of data concerning the indicium, the identity and contents of the individual constituents assembled for insertion into the envelope, and other data (e.g.: the date and time at which the document pages were generated, printed, assembled, and inserted; the time and date at which the indicium was generated and printed, etc.) can be logged to a record keyed to the identifier.

Specific mailpiece processing jobs can be set up in advance which define the class of mail and contents for insertion (e.g., for weight calculation), or such information can be entered in real-time into the system when a job is run. The indicia printed on the document can include a coded print date and can include other fields that may be reserved for use by the mailer. The identifier placed on a document sheet can be scanned at different times and/or locations throughout the mailing process to track its progress through the system. For example, the document indicium can be scanned at points of entry to and exit from the inserter, throughout postal processing and delivery operations conducted by a postal carrier, etc.

By verifying the IBI to ensure that only IBIs with sufficient postage are actually printed on the correct mailpieces, the present invention advantageously reduces waste. It helps to avoid having to apply for a refund for a mailpiece with the wrong IBI, a process that can be time consuming and costly.

In an embodiment of the present invention, a large number of IBI can be obtained on credit and stored. A mailer can pay for the postage when the mailpiece is scanned at the end of the insertion process. Alternatively, the mailer can pay for postage when the mailpiece is scanned by the postal carrier. Under these scenarios, documents for mailing can be prepared using IBIs obtained in bulk. After the mailpiece is created, the inserter system or postal carrier system can verify that the mailpiece is valid (e.g., uses a valid IBI). Once verified, the mailer can then be charged for the postage used for each valid mailpiece. This can advantageously ensure that a mailer pays only for IBIs that bear sufficient postage and that are actually used. That is, if an IBI is generated but not used (e.g., the document is printed but is never mailed), then the customer is not charged for the use of the IBI. If an expired or revoked IBI is scanned by a postal carrier, then the carrier can identify the customer through the identifying aspects of the indicium and can investigate the possibility of theft or fraud.

The document indicia printed on a document in accordance with the present invention can include the USPS Intelligent Mail Barcode. The Intelligent Mail Barcode and an IBI can be combined into a single indicium or be rendered as separate indicia. In conjunction with the Intelligent Mail Barcode, the IBI can be used as a means for establishing the validity of a mailpiece. A document for mailing can be electronically archived and linked to or stored with the indicia. The indicia can operate as a digital signature. Archived records can be retrieved for a variety of purposes. For example, a town of could send out tax statements. A resident can send in a payment for $1000 instead of the proper amount of $2000. The town can review archived records (e.g., the original mailed tax invoice and the returned invoice and payment) to determine the amount of the actual payment and the amount of the payment billed to identify any discrepancy. The resident can return the original invoice or a separate document having one or more indicia that link the reply to the original invoice. A hash or digital signature of all or part of the document can be part of the indicia for the purpose of authenticating that part of the document. For example, an indicium can include an amount of the invoice ($2,000) that is digitally signed.

IBIs may be generated in advance in bulk. For example, a large number of IBIs providing postage for 2 ounce mailings can be provided to a customer and then used for 2 ounce mailpieces. By accounting for the type of paper used for the document, envelope size, the number and type of inserts inside the envelope, a precise determination of the amount of postage needed can be made prior to insertion, and even prior to document printing. During insertion, the document indicia can be scanned by the inserter system. Scanning of the indicia at this stage of processing can provide a check that the proper amount of postage is associated for the mailpiece. If the mailpiece has too little postage, then the inserter can flag the mailpiece postage as deficient.

To accommodate possible changes in the amount of postage a particular mailpiece may need, the present invention can generate dynamic indicia. The dynamic-valued indicia can be associated with a variable amount of postage that can be set or finalized after the insertion process. For example, if a mailer is unsure how much a mailpiece will require (e.g., because the mailer is unsure of the type of envelope that will be used or the weight of the additional inserts that will also be placed in the envelope), then a dynamic-valued indicia can be generated. After the mailpiece is finalized but prior to being passed to a postal carrier for delivery, the dynamic-valued indicia can be associated with a specific postage amount. For example, a record in a database can be created that associates identifying information in an indicium with a specific amount of postage. The customer can be charged at the time the association is made or not until the time the mailpiece is scanned by the carrier. The amount of postage associated with the indicium can be communicated to the postal carrier to ensure proper processing. In an embodiment, such identifying information with which to associate a postage amount is derived from elements from more than one indicium, e.g., from an IBI and an Intelligent Mail Barcode.

An aspect of the present invention allows missing or damaged mailpieces to be recognized and regenerated. For example, each indicium can include information about the order of processing of the mailpieces. This information can alert an inserter system when an IBI is missing (for example, an IBI has been skipped) or is out of order (e.g., indicia no. 200 is scanned by the inserter system before indicia no. 195). If an indicia is missing (i.e., not scanned by an inserter system), then the document or mailpiece associated with the missing IBI can be regenerated. Likewise, when a mailpiece is identified as being damaged, the indicium can be scanned for identifying information, which can be used to regenerate the damaged mailpiece, whereupon it can be mailed. For example, the identifying information can relate to a specific, archived mailpiece or set of documents, which can be reprinted and mailed. Or the identifying information can relate to a list of contents that can be generated and mailed. Thus, a damaged mailpiece can be replaced and mailed to the intended recipient.

During the insertion process, the inserter system can use records tying a document or mailpiece identifier (for example, embodied in an indicium or indicia) to verify that each piece and/or page of a specific mailpiece is properly included in a package for insertion. If a portion of an assembly is missing, then the present invention can accommodate regeneration of the document based on a link between the indicia used for the document as a whole and a stored version of the document.

A document as it is mailed can be scanned and archived, and associated with identifying data on the mailpiece. In this way, an exact copy of a document as mailed and as inserted into the mailpiece can be reproduced as discussed in pending U.S. patent application Ser. No. 11/141,174, filed May 31, 2005, which is hereby incorporated by reference in its entirety.

An aspect of the present invention can be advantageous for bulk mailing. Bulk mail, such as mail that has been presorted into batches to be sent to addresses in the same zip code, can be mailed at discounted rates. Recipients notice the bulk mail frank and often discard such mail without even opening it. In accordance with an embodiment of the present invention, the frank of such bulk mail can be made to appear to be more customized or specific to a particular recipient. This is at least partly because the IBI for each such mailpiece can look different than others. The embodiment can allow a postal carrier to give special discounts based on volume, rate classification, special services, etc. to different customers, while the proof of postage frank does not indicate any such discount. Indeed, the appearance of such a frank can be made to be practically indistinguishable from that used for first class mail, at least to the recipient. In an embodiment, documents for a print file can be selected for printing based upon their destination address or any part thereof, such as the destination zip code or part of the destination zip code. The corresponding preformed IBI can be selected for printing in association with the selected document. Thus, the documents in a print file may be printed out of the order in which they occur in the file, and the corresponding IBIs can be printed out of the order in which they occur in the IBI file. For example, a first document can be selected for printing and its zip code can be identified. The corresponding IBI is selected and printed on the mailpiece that includes the first document. The next document in the print file can be printed if it is addressed to the same zip code as the first document. Otherwise, it is skipped and can be printed later. If the next document is printed, then the corresponding IBI is selected and printed. This can be repeated until all of the documents in the print file addressed to the same zip code have been printed with their corresponding IBIs to form mailpieces. These mailpieces are advantageously output from the printer into a batch suitable for bulk mailing, without the need of further sorting. Other selection mechanisms besides the serial one described above may be used. For example, the documents may be selected in a targeted fashion by identifying a target zip code and then querying a database to obtain a list of document identifiers corresponding to other documents in the print file addressed to the same zip code.

In accordance with embodiments of the present invention, an IBI can encode any data that would be useful in the mailpiece production and mailpiece delivery process. For example, the IBI can encode a date, such as the date on which the IBI was produced or a date in the future, a destination zip code, a meter identifier, a sequence number corresponding to a document in a production batch, a document identifier, identifiers of other documents to be included in the mailpiece, and hashes of the foregoing. The IBI can also encode information that can link it to a database that can correlate such information together. The IBI may also include a hash or signature (for example, an encrypted hash) of all or part of the contents of the document to which it corresponds.

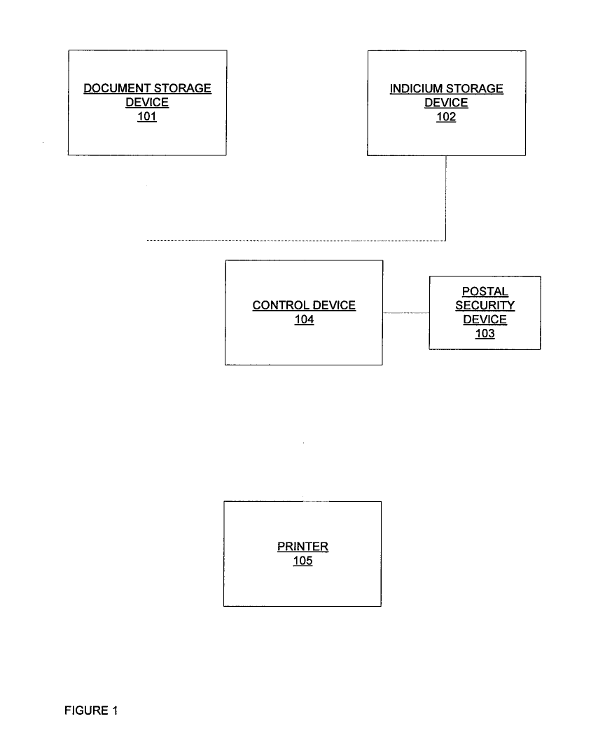

A system in accordance with an embodiment of the present invention is shown in FIG. 1. Document storage device 101 stores electronic documents. An example of an electronic storage device is a memory storing a print file. A memory can be any electronic device that can store digital information, such as RAM, a hard disk, flash memory, and the like. Indicium storage device 102 stores indicia in memory. Examples of indicia include the IBI and the IBI Lite. Postal Security Device 103 is coupled along with document storage device 101 and indicium storage device 102 to controller device 104. As used herein, the term “coupled” means “in communication with”, whether directly or indirectly connected. For example, A coupled to B means that A can be directly connected to B or that A is not directly connected to B, but A is directly connected to C, which in turn is directly connected to B. Controller device can be a processor coupled to a memory. The processor can be a general purpose processor or an Application Specific Integrated Circuit that embodies at least part of the functionality of controller device 104 in its firmware and/or hardware. Memory can store instructions adapted to be executed by the processor to perform the functions of controller device 104. Controller device 104 estimates the printed weight of a document stored in document storage device 101. Based upon the estimate, it calculates a postage value for the document, which can be the amount of postage needed to mail a mailpiece based on the document. Controller device 104 sends a request for a token that encodes the postage value to PSD 103. PSD 103 returns the token to controller device 104, which creates an indicium (such as an IBI) based on the token and other information from the document, such as addressee information, postal services for the document (such as return receipt requested) and class of service (such as first class, bulk mail, and so on). Controller device stores the indicium to indicium storage device 102.

Printer 105 is coupled to controller device 104, document storage device 101 and indicium storage device 102. Printer can receive document data from the document storage device and indicium data from the indicium storage device. It can print the document and the indicium on the same mailpiece. In one embodiment, the printer receives a first bitmap based on a document and a second bitmap based on an indicium. The bitmaps can be superimposed to form a combined bitmap, which the printer can print on the same mailpiece. In another embodiment, the first bitmap can be printed by a first print head (not shown) and the second bitmap can be printed by a second print head (not shown) onto the same mailpiece. In another embodiment, two printers can be used. The first printer can print the first bitmap and the second printer can print the second bitmap on the same mailpiece.

The foregoing is meant to illustrate, and not to limit, the scope of the present invention. One of skill in the art will appreciate from the foregoing embodiments that are not explicitly disclosed but that fall within the scope of the claims.

What is claimed is:

1. A method for processing a mailpiece, comprising:
determining a postage values for a plurality of documents stored in a document file, each document having a document identifier;
sending to a postal security device a request for a token representing the determined values;
receiving the tokens from the postal security device;
generating value-bearing indicia based upon the tokens, each value-bearing indicium including a value-bearing indicium identifier;
storing the plurality of value-bearing indicia in a value-bearing indicia file that is separate from the document file; and
printing a document from the document file and a value-bearing indicium from the value-bearing indicium file on the same mailpiece.

2. The method of claim 1, wherein the postage value for a document is determined based upon the predicted printed weight of the document.

3. The method of claim 1, wherein the postage value for a document is determined based upon at least one physical dimension of the mailpiece.

4. The method of claim 3, wherein the postage value is determined in accordance with shape-based pricing scheme.

5. The method of claim 1, wherein the value-bearing indicium is an IBI or an IBI Lite.

6. The method of claim 1, wherein the value-bearing indicium encodes a date.

7. The method of claim 1, wherein the value-bearing indicium includes a hash based upon the destination zip code.

8. The method of claim 1, wherein the value-bearing indicium includes data to authenticate at least part of the document.

9. The method of claim 1, further comprising scanning the IBI before sending the document to an inserter.

10. The method of claim 1, further comprising scanning the IBI after sending the document to an inserter.

11. The method of claim 1, further comprising determining that a document has been diverted and regenerating the document.

12. The method of claim 1, further comprising:
receiving document data from the document file;
forming a first bitmap based upon the document data;
receiving value-bearing indicium data from the value-bearing indicium file;
forming a second bitmap based upon the value-bearing indicium data;
superimposing the first bitmap and the second bitmap to form a combined bitmap; and
wherein printing the document and the value-bearing indicium on the same mailpiece comprises printing the combined bitmap on the same piece of paper.

13. The method of claim 1, comprising:
receiving document data from the document file;
forming a first bitmap based upon the document data;
receiving value-bearing indicium data from the value-bearing indicium file;
forming a second bitmap based upon the value-bearing indicium data;
wherein printing the document and the value-bearing indicium on the same mailpiece comprises causing a first print head to print the first bitmap on a piece of paper;
causing a second print head to print the second bitmap on the same piece of paper.

14. The method of claim 1, comprising:
receiving document data from the document file;
forming a first bitmap based upon the document data;
receiving value-bearing indicium data from the value-bearing indicium file;
forming a second bitmap based upon the value-bearing indicium data;
wherein printing the document and the value-bearing indicium on the same mailpiece comprises causing a first printer to print the first bitmap on a piece of paper and causing a second printer to print the second bitmap on the same piece of paper.

15. A system for processing a mailpiece, comprising
a document storage device storing electronic documents;
an indicium storage device;
a postal security device;
a controller device coupled to the document storage device, the postal security device and the indicium storage device, wherein the controller device estimates the printed weight of a document stored in the document storage device, determines a postage value based upon the estimated weight, requests a token from the postal security device, receives the requested token, generates an indicium based at least partly upon the token and stores the indicium to the indicium storage device;
a printer coupled to the controller device, the document storage device and the indicium storage device, and that retrieves document data from the document storage device, retrieves indicium data from the indicium storage device and prints the document and the indicium on the same mailpiece.

16. The system of claim 7, wherein the printer stores a first bitmap based upon the document data and a second bitmap based upon the indicium data and superimposes the first bitmap and the second bitmap to form a combined bitmap and prints the combined bitmap on the same paper.

17. The system of claim 7, wherein the printer is comprised of a first print head and a second print head, and the printer stores a first bitmap based upon the document data and a second bitmap based upon the indicium data and the first print head prints the first bitmap on a paper and the second print head prints the second bitmap on the same paper.

18. The system of claim 7, wherein the printer is comprised of a first printer and a second printer, and the first printer stores a first bitmap based upon the document data and the second printer stores a second bitmap based upon the indicium data and the first printer prints the first bitmap on a paper and the second printer prints the second bitmap on the same paper.
